(19) United States
(12) Patent Application Publication
(10) Pub. No.: US 2007/0293143 A1
(43) Pub. Date: Dec. 20, 2007

(54) METHOD OF RF TECHNOLOGY SELECTION FOR GROUP OR BROADCAST SERVICE SUBSCRIBERS

(75) Inventor: John M. Harris, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/424,880

(22) Filed: Jun. 19, 2006

(51) Int. Cl. H04H 1/00

(52) U.S. Cl. 455/3.01

(57) ABSTRACT

The present invention relates to a method and a system for dynamically reducing a number of RF technologies being used for processing at least one broadcast service for a plurality of mobile stations in a wireless communication network. The method comprises determining an RF technology being used by each mobile station. At least one of a plurality of predefined parameters is evaluated if at least two mobile stations of the plurality of mobile stations are using different RF technologies. Further, at least one mobile station of the plurality of mobile stations is switched to a preferred RF technology in response to evaluating the at least one of a plurality of predefined parameters.

### FIELD OF THE INVENTION

The present invention relates generally to broadcast services in a communication network, and more specifically to dynamically reducing a number of Radio Frequency (RF) technologies used for processing one or more broadcast services.

### BACKGROUND OF THE INVENTION

Historically, “broadcasting” referred to the activity of radio and television stations. As cable, satellite and the Internet have developed, it is often used to describe the simultaneous real-time distribution of any media or content from one source to many recipients, using any transport method. In a wireless communication network, conventional systems use radio waves for transporting media or content between a plurality of mobile stations. However, today, multi-RF technology networks for broadcasting are proliferating. A mobile station can now broadcast content to other mobile stations even if the RF technologies implemented by each user is different. Some RF technologies used are High Rate Packet Data (HRPD), High-speed downlink packet access (HSDPA), IEEE 802.16e, IEEE 802.11, General Packet Radio System (GPRS), Code division multiple access (CDMA) 2000 and Media forward link only (FLO), to name a few.

In existing wireless communication networks, least cost routing schemes and load balancing schemes are used to reduce the cost of a particular broadcast service and to improve performance of the wireless communication network.

However, in most existing methods, radio and network resources are used inefficiently while broadcasting. First, if a group of mobile stations are in the same paging zone, existing systems do not provide a method to use a group page in a manner that maximizes cost savings. Second, if multiple mobile stations are in the same sector, shared channels are not used, thus making inefficient use of network resources. Third, battery life is sacrificed when a mobile station monitors multiple RF technologies.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram depicting an exemplary embodiment of a communication system in which the present invention may be utilized.

FIG. 2 is a block diagram depicting an exemplary embodiment of a mobile station or base transceiver station shown in FIG. 1 in which the present invention may be implemented.

FIG. 3 is a flow diagram depicting an exemplary embodiment of a method in accordance with a first aspect of the present invention.

FIG. 4 is a flow diagram depicting an exemplary embodiment of a method in accordance with a second aspect of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for dynamically reducing a number of RF technologies used for processing one or more broadcast services. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for dynamically reducing a number of RF technologies used for processing one or more broadcast services described herein. The non-processor circuits may include, but are not limited to, a radio receiver, a radio transmitter, signal drivers, clock circuits, power source circuits, and user input devices. As such, these functions may be interpreted as steps of a method to perform the dynamic reduction a number of RF technologies used for processing one or more broadcast services described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the present invention enables detection of a group of mobile stations (MSs) which are most likely to receive a common broadcast service, such as content or a call, or a broadcast service in a cellular, mesh network, or an ad-hoc network. Each MS in the group of MSs may use a different RF technology to process the broadcast service. The RF technology used may be, for example, High Rate Packet Data (HRPD), High-speed downlink packet access (HSDPA), IEEE 802.16e, IEEE 802.11, General Packet Radio System (GPRS), Code division multiple access (CDMA) 2000 and Media forward link only (FLO). The present invention facilitates switching one or more MSs to a preferred RF technology based on one or more predefined parameters when a broadcast service is received or prior to when the broadcast service is anticipated to be received by the group of MSs.

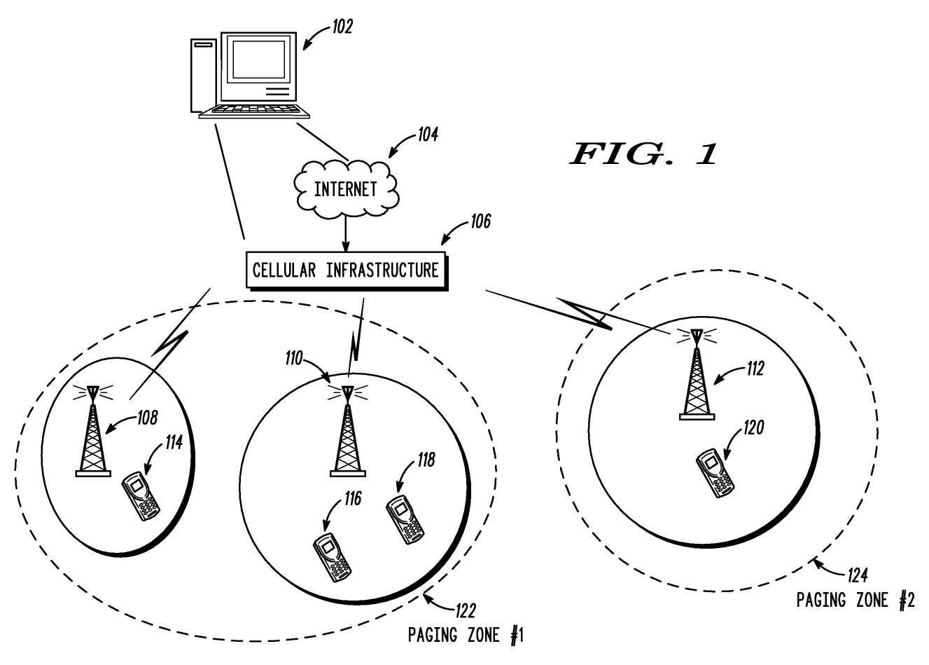

Referring now to the drawings, and in particular to FIG. 1, a block diagram of an exemplary communication system that can be used with the present invention is shown. Those skilled in the art will recognize and appreciate that the specifics of this illustrative example are not specifics of the invention itself and that the teachings set forth herein are applicable in a variety of alternative settings. For example, since the teachings described do not depend on the type of wireless communication network or the number of mobile stations in the group of mobile stations, they can be applied to any type of wireless communication network and any number of mobile stations. For clarity, only four mobile stations (MSs) are shown in this embodiment.

The source of broadcast content that is sent to the MSs is represented by source 102. Source 102 can be, for example, a content server on the Internet, a subscriber device, an email server, a web server, a video server, and the like. The source 102 is directly or indirectly coupled to cellular infrastructure 106 which enables the transmission of the broadcast content to MSs 114-120. The Internet 104 provides one means of conveying the broadcast content to the cellular infrastructure 106. The cellular infrastructure 106 contains the wireless infrastructure for conveying information from the Internet 104 or content server 102 to the MSs 114-120. The cellular infrastructure 106 may contain elements commonly known in the art, such as a Packet Data Serving Node (PDSN)/GPRS support node (GSN), and Radio Network Controller (RNC)/Base Station Controller (BSC). The Base Transceiver Stations (BTSs) or node Bs 108, 110 and 112 are connected to the cellular infrastructure 106 and the MSs 114-120 for transmitting signals between the components. In accordance with an exemplary embodiment of the invention depicted in FIG. 1, MSa 114, MSb 116 and MSc 118 are in a same paging zone 122. MSa 114, however is in a different sector (also known in the art as a “cell”) of paging zone 122 than MSs b and c. MSd 120 is in a different paging zone 124. It will be readily appreciated by one of ordinary skill in the art that at a particular time instant, any number of MSs can be present in a paging zone. In order to show a practical example of the various teachings herein, however, paging zone 122 is shown with three MSs and paging zone 124 is shown with only one MS. MSs 114-120 may be, for example, a cellular telephone, laptop computer, personal digital assistant, and the like.

A broadcast service originated at a source 102, such as that potentially used in a common Short Message Service (SMS), a group e-mail, broadcast video, a tele-conference call, presence information, gaming, or a group PTT call, can be received by MSs 114, 116, 118 and 120. One or more of the MSs may be enabled to use a different RF technology for processing the broadcast service. The present invention facilitates using available information to identify situations where efficiencies can be gained by using a common preferred RF technology. Thereafter, one or more of the MSs 114-120 are switched to the preferred RF technology depending on a plurality of predefined parameters. Using a preferred RF technology may reduce traffic channel cost, paging cost and may help utilize radio and network resources efficiently and improve battery life.

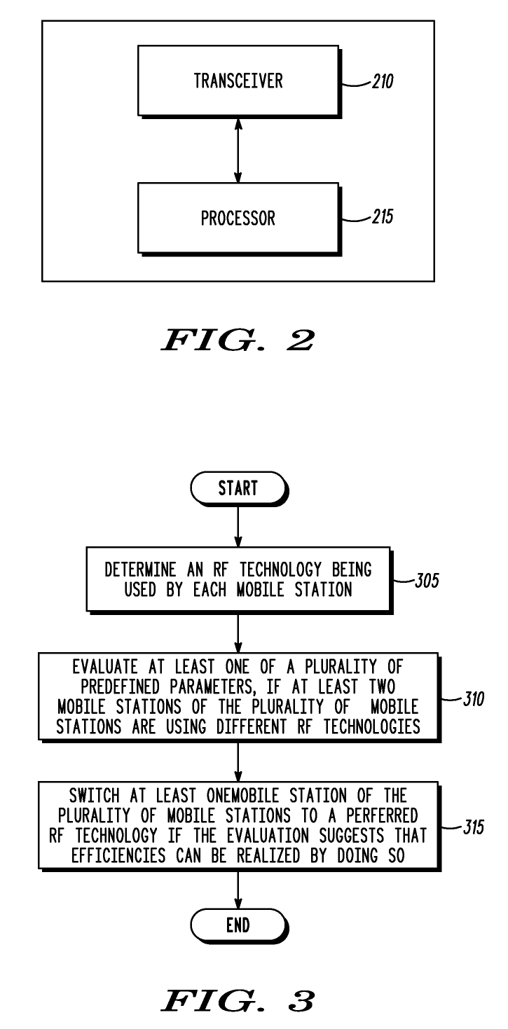

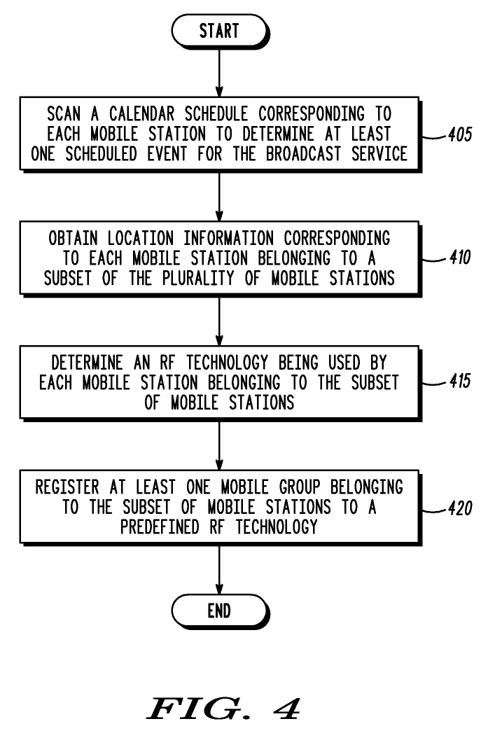

The present invention can be realized in hardware, software, or a combination of hardware and software in the MS 114-120, the BTS (node B) 108-112, or any combination of the two. Turning now to FIG. 2., a transceiver 210 in conjunction with a processor 215 in either the MS 114-120 or the BTS 108-112 determines the RF technology used by each of the plurality of MSs 114-120 at a particular time instant. If two or more MSs are using different RF technologies, the processor 215, which is adaptively coupled to the transceiver 210, evaluates one or more of a plurality of predefined parameters. The plurality of predefined parameters may comprise calendar schedule information corresponding to one or more MSs 114-120, presence status corresponding to one or more MSs 114-120, inclusion of one or more MSs 114-120 in a buddy list, historical traffic statistics or call reservation information, compatibility of an RF technology with one or more MSs 114-120, geographic location of the MSs 114-120, and movement patterns of the MSs 114-120. The transceiver 210 may be configured to receive one or more of the calendar schedule information, presence status, buddy list information, historical traffic statistics or call reservation. Details on how the parameters are used with the present invention are provided during the discussion of FIGS. 3 and 4 later herein.

Upon evaluation of the predefined parameters, the transceiver 210, in conjunction with the processor 215, broadcasts a switch message to one or more MSs instructing the MS(s) to switch to a preferred RF technology for accessing a broadcast service. The preferred RF technology can be selected based on, for example, the RF technology with the best RF condition taking into consideration the RT technology compatibility of one or more MSs. The transceiver 210 can be configured to obtain the RF technology compatibility corresponding to the preferred RF technology for the one or more MSs.

Turning now to FIG. 3, a flow diagram of a method for dynamically reducing a number of RF technologies used for processing at least one broadcast service for a plurality of MSs in a wireless communication network is shown in accordance with an embodiment of the present invention. A broadcast service, such as that used in a tele-conference call or a group SMS, may be scheduled to be received at a plurality of MSs 114-120. The MSs 114-120 may be operating in a multiple RF technology environment and may each use a different RF technology to process the broadcast service. The multiple RF technologies may also be provided by different RF operators. At step 305, the RF technology used by each MS 114-120 is determined. One of ordinary skill in the art will recognize that a MS can be capable of using a plurality of RF technologies. After the RF technology used by each MS 114-120 is determined, if two or more MSs are using different RF technologies, one or more of a plurality of predefined parameters are evaluated at step 310. As previously mentioned, the plurality of predefined parameters can comprise calendar schedule information corresponding to one or more MSs 114-120, presence status corresponding to one or more MSs 114-120, inclusion of one or more MSs 114-120 in a buddy list, historical traffic statistics or call reservation information, compatibility of an RF technology with one or more MSs 114-120, geographic location of the MSs 114-120, and movement patterns of the MSs 114-120. In response to evaluating the plurality of predefined parameters, one or more MSs 114-120 can be switched to a preferred RF technology at step 315.

One of ordinary skill in the art will appreciate that calendar schedule information and call reservation information can be obtained automatically from a MS or after approval of a MS user. The calendar schedule information can be used to detect when a broadcast service such as a teleconference is going to occur. Presence status can be obtained from, for instance, location updates or beacon signals that the MS periodically sends a BTS to indicate the MS's presence in a particular paging zone. When a broadcast service occurs, the presence status can indicate if some of the plurality of MSs are in the same paging zone or sector as that of a particular MS.

A buddy list refers to a list of people whose presence information is being monitored. Typically the list includes people that the user frequently or typically communicates with over instant messaging or some other chat or messaging application. Alternatively, the list includes people in the user's address book. Yet another alternative is a list of people who are on the same group call recipient list as the user, i.e. other people who tend to receive group calls that are also addressed to the user. The list can also be people who are interested in the same broadcast content issue, e.g. the same sports video channel clips.

An example of how a buddy list may be used with the method of the present invention will now be described. In the current example, MSa 114 is in a given geographic region such as shown in FIG. 1. MSb 116 and MSc 118 are in the same geographic region, and are included in the buddy list of MSa 114. However, MSb 116 and MSc 118 have their presence set to “do not disturb.” In this scenario, MSb 116 and MSc 118 are unlikely to be called because their presence indicates that they are unavailable. Thus it is unlikely that a group call will occur that will include MSa 114, MSb 116 and MSC 118. As a result, MSa 114 will not change the RF technology that it is currently using in order to be on the same RF technology as that of MSb 116 and MSc 118. Here, the evaluation of step 310 does not suggest that efficiencies will be realized by MSa 114 switching to the RF technology used by MSb 116 and MSc 118.

Continuing with the same example, lets assume two additional mobile stations, MSe and MSf (not shown), are in the same geographic region as MSa 114 and are on the buddy list of MSa 114, but are operating on a different RF technology than MSa 114. MSe and MSf have their presence set to “available.” In this scenario, MSe and MSf are likely to receive calls. Thus, it is relatively likely that a group call will occur that will target MSa 114, MSe and MSf. As a result, MSa would switch to the RF technology used by MSe and MSf. Here, the evaluation of step 310 suggests that efficiencies will be realized by MSa 114 switching to the RF technology used by MSb 116 and MSc 118 because the three MSs are likely to be participants in a group call.

An example of how a call reservation may be used with the method of the present invention will now be described. Let's assume that call reservation or historical statistics for MSa 114 indicate that a call is likely to occur or is scheduled to occur among MSa 114, MSb 116, MSc 118 and MSd 120 at 3 p.m. Based on this information, some time prior to 3 p.m., the MSs of the four users could preemptively determine which RF technologies MSa 114, MSb 116, MSc 118 and MSd 120 are using and then change RF technology as appropriate so that they are all using the same RF technology. In another example, the user of MSa 114 may have set up a call reservation that indicates he wishes to call MSb 116, MSc 118 and MSd 120 as soon as all three of them are available. In this case the MSs may switch to the same RF technology when it appears likely that the call reservation criteria will be satisfied.

As another example, let's assume that the user of MSa 114 wishes to call users of MSb 116, MSc 118 and MSd 120 as soon as the users of MSb 116, MSc 118 and MSd 120 are all in Schaumburg, Ill. In this example, when MSa 114, MSc 118 and MSd 120 detect through presence information that the users of MSc 118 and MSd 120 are already in Schaumburg and the user of MSb 116 appears to be in route to Schaumburg—arriving shortly, MSa 114, MSc 118 and MSd 120 preemptively determine which RF technologies MSa 114, MSc 118, MSd 120 and MSb 116 are using and then change RF technology as appropriate so that they are all using the same RF technology.

As an example of how compatibility of an RF technology with one or more MSs 114-120 can be used in conjunction with calendar schedule information, consider that a user's MS is capable of a newest RF technology X. The user may prefer to use the newest RF technology X for processing a broadcast service, but is also capable of using RF technology Y. The user may have scheduled a tele-conference call with a plurality of other users and may have stored a reminder of the scheduled time of the tele-conference call in the MS's calendar. The calendar schedule information can be used to detect the scheduled time when the tele-conference call is likely to occur. The user can be located geographically near a number of the plurality of other users (e.g., in the same paging zone or in the same sector). The number of other users may be capable of using RF technology Y, but not capable of using RF technology X. In accordance with the present invention, the MS would switch to RF technology Y from RF technology X. Switching to RF technology Y may reduce the cost of the tele-conference call for the MS, since the user of the MS can now split the cost with the number of MSs likely to participate in the tele-conference call. Also, using calendar schedule information, the scheduled time of the tele-conference call can be known prior to its occurrence. Therefore, the MSs can switch to RF technology Y before the tele-conference call occurs, so that extra costs for paging the plurality of MSs can be avoided. Additionally, extra latency and signaling costs are avoided if the broadcast service arrives after the MS has switched to RF technology Y.

In another exemplary scenario, a plurality of MSs can be a part of a mesh network. A MS, MSa, in the mesh network can detect that a number of other MSs in the mesh network are located geographically near MSa using presence status of the other MSs. MSa may be capable of using RF technology X and RF technology Y for a broadcast service in the mesh network. However, MSa may be currently using RF technology X. The number of other MS may be capable of using only RF technology Y for the broadcast service in the mesh network. Now, if the number of other MSs are likely to receive calls or content of interest to MSa, then in accordance with the present invention, MSa may prefer to use RF technology Y. Therefore, MSa may switch from RF technology X to RF technology Y. The switching of RF technology can reduce the cost of the broadcast service for MSa, because the cost can be split with the number of other MSs receiving the same broadcast service.

Those of ordinary skill in the art will recognize that switching the RF technology to a preferred RF technology enables significant traffic channel cost savings. Traffic channel costs are saved by avoiding downloading of redundant information across different RF technologies used by a number of MSs that are located geographically near one another. Also, traffic channel costs are reduced regardless of when a MS switches RF technologies. Therefore, the RF technologies can be switched preemptively before beginning the broadcast service.

Turning now to FIG. 4, a flow diagram of a method for facilitating one or more MSs to access a broadcast service in a wireless communication network is shown in accordance with an embodiment of the present invention. Each of the plurality of MSs may be capable of using a plurality of RF technologies, such as HRPD, HSDPA, IEEE 802.16e, IEEE 802.20, IEEE 802.11, GPRS, CDMA 2000, 3GPP, 3GPP2 and Media FLO. Prior to receiving the broadcast service, a calendar schedule corresponding to each MS may be scanned at step 305. One or more scheduled events for the broadcast service are determined from the calendar schedules of the plurality of MSs. The calendar schedules of the plurality of MSs may imply that only a subset of the MSs are prospective participants in the broadcast service. Once a scheduled event for the broadcast service and the subset of the MSs likely participating in the broadcast service are determined, location information corresponding to each MS in the subset is obtained at step 410.

At step 415, the RF technology used by each MS in the subset of MSs is determined. Those of ordinary skill in the art will recognize that each of the MSs may be capable of using one or more different RF technologies. However, a MS may prefer to use a certain RF technology due to the quality of service provided by the certain RF technology. At step 420, one or more MSs in the subset is registered to a preferred RF technology. For example, the subset of MSs may include two groups of MSs, the first MS group using a common RF technology and the second MS group using a different RF technology. If the number of MSs in the first group is larger than the number of MSs in the second group, the second group may be registered to the common RF technology used by the first group. In this example, the common RF technology is the preferred RF technology.

As previously mentioned, selecting the preferred RF technology can depend on various factors, such as an RF condition corresponding to the plurality of RF technologies. For example, a particular RF technology may have a better RF condition than the rest of the RF technologies. In such a case, that RF technology can be selected as the preferred RF technology, provided the plurality of MSs are compatible with that RF technology. Also, from the plurality of MSs, there may be more than a threshold number of apparently static MSs in a same sector or a same paging zone. These apparently static MSs can be registered to a common RF technology. Moreover, the rest of the MSs from the plurality of MSs that are not static can also be registered to the common RF technology. Those skilled in the art will realize that registering to an RF technology used by the apparently static MSs can be particularly useful in a loaded sector or in poor signal strength conditions, since a probability of sharing broadcast content can then minimized.

In an embodiment of the present invention, a MS can be registered to a preferred RF technology when the MS is idle or prior to receiving the broadcast service. This is particularly appropriate if the broadcast service is delay sensitive, for example if the broadcast service is a tele-conference. In another embodiment of the present invention, the MS can be registered to the preferred RF technology during the broadcast service. This can be appropriate if the broadcast service is delay tolerant, for example if the broadcast service is a group e-mail. However, delay sensitivity should be determined taking into consideration slowest RF technology and wakeup latency of an RF technology.

In an embodiment of the present invention, a broadcast service that is not real time (e.g., group e-mails, SMS) can be scheduled to maximize use of shared channels so that broadcasting overlaps are avoided across different RF technologies. Messages, packets or transfer requests corresponding to the broadcast service can be queued at the MS, network or RAN, or on a plurality of MSs that may later switch to a preferred RF technology to process the broadcast service. Moreover, RF technologies can be switched periodically such that the broadcast service is harvested across each RF technology used by the plurality of MSs.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for dynamically reducing a number of RF technologies being used for processing at least one broadcast service for a plurality of mobile stations in a wireless communication network, the method comprising:
determining an RF technology being used by each mobile station;
evaluating at least one of a plurality of predefined parameters associated with a mobile station of the plurality of mobile stations if at least two mobile stations of the plurality of mobile stations are using different RF technologies; and
switching at least one mobile station of the plurality of mobile stations to a preferred RF technology in response to evaluating the at least one of a plurality of predefined parameters.

2. The method for claim 1, wherein the plurality of predefined parameters comprises at least one of calendar schedule information, presence status, historical traffic statistics, a buddy list, call reservation information, RF technology compatibility, relative location of the mobile station and movement of the mobile station.

3. The method of claim 1, wherein the preferred RF technology is selected based on an RF condition associated with the number of RF technologies.

4. The method of claim 1, wherein the switching step is performed preemptively before beginning the at least one broadcast service.

5. The method of claim 1, wherein the switching step is performed during the at least one broadcast service.

6. A method for facilitating at least one mobile station of a plurality of mobile stations in accessing a broadcast service in a wireless communication network, the method comprising:
scanning a calendar schedule corresponding to each mobile station of the plurality of mobile stations to determine at least one scheduled event for the broadcast service;
obtaining location information corresponding to each mobile station belonging to a first subset of the plurality of mobile stations, wherein the first subset of the plurality of mobile stations comprises mobile stations which are prospective participants of the broadcast service;
determining an RF technology being used by each mobile station belonging to the first subset of the plurality of mobile stations; and
registering at least one mobile set belonging to the first subset of the plurality of mobile stations to a preferred RF technology.

7. An apparatus comprising:
a transceiver; and
a processor adaptively coupled to the transceiver and configured to:
determine an RF technology of the plurality of RF technologies used by each mobile station of a plurality of mobile stations operating in a wireless communication network;
evaluate at least one of a plurality of predefined parameters, if at least two mobile stations of the plurality of mobile stations are using different RF technologies; and
broadcast a switch message to at least one mobile station of the plurality of mobile stations instructing the at least one mobile station to switch to a preferred RF technology for accessing a broadcast service.

8. The apparatus of claim 8, wherein the transceiver is further configured to receive at least one of calendar schedule information, presence status, historical traffic statistics, a buddy list, call reservation information, RF technology compatibility, relative location of the mobile station and movement of the mobile station.

9. The apparatus of claim 8, wherein the transceiver is further configured to obtain an RF technology compatibility corresponding to the preferred RF technology for the at least one mobile station of the plurality of mobile stations.

10. A mobile station (MS) comprising:
a transceiver;
a processor, adaptively coupled to the transceiver and configured to:
send at least one of a calendar schedule information and a presence status corresponding to the MS to a base transceiver station;
determine an RF technology compatibility of the MS with a plurality of RF technologies; and
receive a switch message instructing the MS to switch to a preferred RF technology, wherein the plurality of RF technologies includes the preferred RF technology.

11. The mobile station of claim 12, wherein the processor is configured to switch to the preferred RF technology when the processor receives the switch message.
